(19) United States
(12) Patent Application Publication
(10) Pub. No.: US 2026/0200442 A1
(43) Pub. Date: Jul. 16, 2026

(54) BRAKE SYSTEM OF A MOTOR VEHICLE WHICH CAN BE DRIVEN ELECTRICALLY BY MEANS OF AN ELECTRIC MACHINE

(71) Applicant: Schaeffler Technologies AG & Co. KG, Herzogenaurach (DE)

(72) Inventors: Simon Ortmann, Pulheim (DE); Benedikt Grubauer, Neresheim (DE)

(73) Assignee: Schaeffler Technologies AG & Co. KG, Herzogenaurach (DE)

(21) Appl. No.: 19/133,223

(22) PCT Filed: Nov. 8, 2023
(86) PCT No.: PCT/DE2023/100834

§ 371 Date: May 28, 2025

(30) Foreign Application Priority Data
Nov. 28, 2022 (DE) 10 2022 131 370.0

(51) Int. Cl. B60T 1/06; B60T 13/58; F16D 51/00; F16D 65/06; F16D 65/22; F16D 65/833; F16D 121/02

(52) U.S. Cl. CPC B60T 1/062; B60T 13/588; F16D 51/00; F16D 65/06; F16D 65/22; F16D 65/833; F16D 2121/02

(57) ABSTRACT

The invention relates to a brake system (1) of a motor vehicle (3) which can be driven electrically by means of an electric machine (2), wherein the brake system (1) comprises a drum brake (4) with a brake drum (5), which can be loaded with a frictional torque by means of a brake shoe (6) which can be moved radially in the direction of the brake drum (5) by a brake actuator (7), and the electric machine (2) has a rotor (8) which is coupled in a torque-transmitting manner to at least one vehicle wheel (10) of the motor vehicle (3), wherein the drum brake (4) is received in a brake housing (9), and the brake shoe (6) is connected in a torque-transmitting manner to the rotor (8) of the electric machine (2) and is mounted such that it can be moved axially and radially with respect to the non-rotational brake drum (5), with the result that the brake shoe (6) can be moved into a frictionally locking connection with a shell surface (11) of the brake drum (5) by way of the brake actuator (7) actuating in the axial direction.

### CROSS-REFERENCE TO RELATED APPLICATIONS

This application is the United States National Phase of PCT Appln. No. PCT/DE 2023/100834 filed Nov. 8, 2023, which claims priority to German Application No. DE 102022131370.0 filed Nov. 28, 2022, the entire disclosures of which are incorporated by reference herein.

### TECHNICAL FIELD

The present disclosure relates to a brake system of a motor vehicle which can be driven electrically by means of an electric machine. The brake system includes a drum brake having a brake drum which can be loaded with a frictional torque by means of at least one brake shoe which can be moved radially in the direction of the brake drum by a brake actuator, and the electric machine has a rotor which is coupled in a torque-transmitting manner to at least one vehicle wheel of the motor vehicle.

### BACKGROUND

Electric motors are increasingly being used for propulsion in motor vehicles to provide alternatives to internal combustion engines that require fossil fuels. Significant efforts have already been made to improve the suitability of electric drives for everyday use and also to be able to offer users the driving comfort which they are accustomed to. A detailed description of an electric drive can be found, for example, in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle which comprises an electric motor arranged coaxially with respect to a bevel gear differential.

Motor vehicles of this type with a hybridized or electrified drivetrain can not only accelerate, but also brake with the aid of an electric machine. During the braking process, the electric machine is operated as a generator and the recuperated energy is used to charge the battery, for example. For safety reasons, however, an additional mechanical braking device is still required. For drives close to the wheel, such as a wheel hub motor or an electric axle, this results in a more difficult installation space situation.

In particular, a vehicle comprising an electric wheel hub drive, a so-called e-wheel drive, often uses brakes with plates to brake the vehicle. However, disk brakes with floating calipers, disk brakes with fixed calipers, drum brakes and multi-disk brakes are also known.

DE 10 2019 120 409 A1, for example, discloses a braking device for a wheel hub drive assembly in which the braking partners, which are fixed relative to the circumferential direction, have cooling channels. The axially movable braking partner is actuated via brake cylinders. The braking partner, which is movable in the circumferential direction, is designed as a plate carrier.

There is also an increasing requirement to reduce or completely avoid emissions of brake abrasion particles, which often occur as particulate matter.

### SUMMARY

The present disclosure provides a brake system of a motor vehicle which can be driven electrically by means of an electric machine. The brake system includes a drum brake having a brake drum which can be loaded with a frictional torque by means of at least one brake shoe which can be moved radially in the direction of the brake drum by a brake actuator, and the electric machine has a rotor which is coupled in a torque-transmitting manner to at least one vehicle wheel of the motor vehicle. The drum brake is received in a brake housing and the brake shoe is connected in a torque-transmitting manner to the rotor of the electric machine and is mounted so as to be axially and radially movable relative to the rotationally fixed brake drum, such that the brake shoe can be brought into frictionally locking connection with an shell surface of the brake drum by the brake actuator actuating in the axial direction.

The brake system according to the disclosure supplements the recuperation of the electric machine in generator mode in driving situations where this alone cannot provide the desired braking energy. These are, for example, driving situations with a low vehicle speed or rotational speed of the electric machine or a stopping to a standstill or braking at a low temperature.

An additional, encapsulated brake provides that the braking energy can be transferred as heat to the thermal management system of the motor vehicle without having to store the energy in the vehicle battery, for example. In addition, brake dust particles are not released into the environment. If legal regulations allow this in the future, it may also be possible, for example, to dispense with wheel brakes on one axle.

This type of brake is sometimes referred to as a complementary brake.

The brake may be arranged in a brake housing. The brake housing encloses the brake. A brake housing can also accommodate one or more brake actuators. The brake housing can also be part of a cooling system and designed in such a way that cooling fluid is fed to the brake system via the brake housing and/or the heat can be dissipated to the outside via the housing surfaces. The brake housing also protects the complementary brake from external mechanical and/or chemical influences. In particular, a brake housing can be formed from a metallic material. The brake housing can be formed from a metallic cast material, such as gray cast iron or cast steel. In principle, it is also conceivable to make the brake housing entirely or partially out of plastic. It is also possible for the brake housing to be designed in one piece or in several parts.

The brake housing can also be designed completely or partially as part of a motor housing of an electric machine or a transmission housing of a transmission coupled to the electric machine. The brake housing and the motor housing or the transmission housing may form a single structural unit. For example, the brake housing can be screwed to the motor housing or the transmission housing. The brake housing may be designed in such a way that abrasion particles generated during braking cannot escape from the brake housing. This prevents unwanted pollution of the environment with brake abrasion particles. Braking noise with respect to the environment can also be reduced by encapsulating the brake system in this way. With this encapsulation, the braking performance of the brake system is independent of the weather conditions outside the motor vehicle.

In particular, a brake actuator has the function of actuating the brake, i.e. setting it to a frictional operating state and an operating state released from the frictionally locking connection. In particular, the brake actuator can be actuated pneumatically, hydraulically, by an electric motor, mechanically, electromagnetically or any combination of these.

The brake system according to the disclosure may be provided for a motor vehicle which can be driven electrically by means of an electric machine. Electric machines within the meaning of the present application are used to convert electrical energy into mechanical energy and/or vice versa, and generally include a stationary part referred to as a stator or armature and a part referred to as a rotor which is movable relative to the stationary part. In connection with the present disclosure, an electric machine can be designed in particular as a rotary machine. With such electric rotary machines, a distinction is made between radial flux machines and axial flux machines. A radial flux machine has magnetic field lines that extend in the radial direction in the air gap formed between rotor and stator, while in the case of an axial flux machine, the magnetic field lines extend in the axial direction in the air gap formed between rotor and stator. In the context of the present disclosure, an electric machine is provided in particular for use within a drivetrain of a hybrid or all-electric powered motor vehicle. In particular, the electric machine is dimensioned such that vehicle speeds of more than 50 km/h, more than 80 km/h, or more than 100 km/h can be achieved. The electric machine may have an output of more than 30 kW, more than 50 kW, or more than 70 kW. Furthermore, the electric machine may provide speeds greater than 5000 rpm, greater than 10,000 rpm, or greater than 12,500 rpm.

The electric machine can have a housing, also known as a motor housing. The motor housing encloses the electric machine. A motor housing can also accommodate the control and power electronics unit, and, for example, also at least parts of the braking system. The motor housing can also be part of a cooling system for the electric machine and designed in such a way that cooling fluid is fed to the electric machine via the motor housing and/or the heat can be dissipated outwards via the motor housing surfaces. In addition, the motor housing protects the electric machine and any electronics from external mechanical and/or chemical influences. A motor housing of the electric machine can be made of a metallic material in particular. The motor housing can be formed from a metallic cast material, such as gray cast iron or cast steel. In principle, it is also conceivable to form the motor housing entirely or partially from a plastic. It is also possible for the motor housing of the electric machine to be designed in one piece or in several parts.

A rotor is the rotating (spinning) part of an electric machine. In particular, the rotor includes a rotor shaft and one or more rotor bodies formed from rotor laminated cores and arranged in a rotationally fixed manner on the rotor shaft. The rotor shaft can be hollow, which on the one hand results in weight reduction and on the other hand allows the supply of lubricant or coolant to the rotor body. In particular, the rotor shaft can be coupled to the brake shaft of the complementary brake.

The electric machine and/or the brake can be coupled to a transmission which is designed in particular to generate a drive torque for the motor vehicle. The drive torque may be a main drive torque such that the motor vehicle is driven exclusively by the drive torque.

It is also possible in particular for the electric machine and/or the brake and the transmission to be arranged in a common drivetrain housing. Alternatively, it would of course also be possible for the electric machine to have a motor housing and the transmission to have a transmission housing, and it is then possible to realize the structural unit by fixing the transmission assembly in relation to the electric machine. This structural unit is sometimes also referred to as an e-axle. The drivetrain housing may be made of a metallic material, in particular aluminum, grey cast iron or cast steel, in particular by means of a primary forming process such as casting or die casting. In principle, however, it would also be possible to form the drivetrain housing from a plastic. In particular, the drivetrain housing may have a pot-like basic shape so that the electric machine and the transmission can be inserted into the drivetrain housing via the open end face of the drivetrain housing.

The electric machine may have a motor housing and/or the transmission may have a transmission housing, with it then being possible to realize the structural unit by fixing the transmission in relation to the electric machine. The transmission housing is a housing for accommodating a transmission. It has the task of guiding existing shafts via the bearings and providing the wheels (possibly cam disks) with the degrees of freedom they require under all loads without hindering them in their rotational and possibly path movement, as well as absorbing bearing forces and support torques. A transmission housing can be single-or multi-shell, i.e. undivided or divided. In particular, the transmission housing should be able to dampen noise and vibrations as well as safely absorb hydraulic fluid. The transmission housing may be made of a metallic material, in particular aluminum, grey cast iron or cast steel, in particular by means of a primary forming process such as casting or die casting.

Furthermore, the transmission can be configured as a planetary transmission or include a planetary transmission. The planetary transmission can have a sun gear and multiple planet gears which mesh with the sun gear, are rotatably mounted in a planet gear carrier and which rotate around the sun gear, as well as a ring gear which is arranged coaxially with respect to the sun gear and in which the planet gears roll.

The transmission can also have a differential transmission. A differential transmission is a planetary transmission comprising one drive and two outputs. It usually has the function of driving two vehicle wheels of a motor vehicle in such a way that they can rotate at different speeds in bends, but with the same propulsive force.

In order to realize different drive or operating modes for the motor vehicle, one or more separating clutches can be provided within the torque path between the electric machine and a vehicle wheel. A separating clutch can be arranged, for example, between the output of the electric motor and the input of the transmission so that the electric machine can be decoupled from the transmission, allowing the motor vehicle to be operated in a coasting mode. It would also be conceivable to arrange a separating clutch between the output of the transmission and a vehicle wheel or the vehicle wheels, which would also make it possible to realize a coasting mode of the motor vehicle. Finally, it is also possible to arrange a separating clutch between the input of the brake system and the output of the electric machine, which allows the braking system to be completely decoupled from the electric machine.

For the purposes of this application, motor vehicles are land vehicles that are moved by engine power without being bound to railroad tracks. A motor vehicle can, for example, be selected from the group of passenger cars, trucks, mopeds, light motor vehicles, motorcycles, buses and coaches or tractors.

According to an example embodiment, it is possible for brake actuator to be coupled to a brake shoe carrier which carries the brake shoe and is connected in a rotationally fixed manner to a rotatably mounted brake shaft and which converts an axial release movement of the brake actuator into a radial displacement movement of the brake shoe. According to a further development, it is also possible for the brake shoe carrier to have a coupling ring which is connected in a rotationally fixed manner to the brake shaft and at least one carrier segment which can be moved relative to the coupling ring and to which the brake shoe is fixed.

Furthermore, according to an example embodiment, it is also possible for the coupling ring to have a sliding portion which is tilted relative to a radial plane and on which the carrier segment is displaceably guided. This embodiment provides a simple and cost-effective means of converting an axial movement into a radial movement.

According to a further embodiment, it is possible for an elongated hole extending in the direction of displacement to be formed in the carrier segment, which elongated hole is penetrated by at least one guide means extending from the sliding portion through the elongated hole, such that the carrier segment is guided movably in the direction of displacement and captively relative to the coupling ring. This makes it possible to realize a reliable guide which can be produced cost-effectively.

Furthermore, the brake system can also be further developed in such a way that a sliding segment is arranged between the carrier segment and the sliding portion, which improves the sliding movement of the two components against each other.

In an example embodiment, it is also possible for the spring force of a spring element to act with a radially inwardly directed spring force component on the carrier segment.

This means that centrifugal forces acting on the brake shoe can be compensated for and the carrier segment can be returned to a defined starting position even if the brake actuator is no longer actuated.

The brake actuator may be designed as a hydraulically actuatable central release mechanism which acts on a release bearing arranged in the release direction between the central release mechanism and the carrier segment, which release bearing in turn can be coupled to the carrier segment to transmit the release movement.

Therefore, a tried-and-tested release system can be used, which is available at low cost and has a high level of operational safety.

In accordance with a further development, it is also possible for the brake actuator to be designed as a central release mechanism which has a central release mechanism piston that can be moved axially by hydraulic pressurization by means of a hydraulic fluid, a rotationally fixed disk with at least one cooling channel connected to the brake cooling circuit being arranged at the axial end of the central disengaging piston that is in the release direction, which disk can be brought into frictionally locking connection with the brake disk by the central release mechanism. In particular, this allows a large braking force to be provided with short reaction times of the brake actuator.

The central release mechanism may be integrated in a hydraulic release system. A hydraulic release system usually has a master cylinder that transmits the pressure generated on the master cylinder to the slave cylinder, in this case a central release mechanism, via a hydraulic pressure line. The hydraulic pressure can in particular also be provided by means of what is known as a power pack, which consists of a hydraulic pump and a hydraulic pressure accumulator that can be acted upon by the hydraulic pump. In this case, a pressure chamber of the slave cylinder can also be pressurized hydraulically, for example by a master cylinder that is controlled by means of an electric motor of a controller or by a hydraulic pump, optionally with the cooperation of a pressure accumulator. A power pack can be used in an advantageous manner which switches multiple pressure circuits, in particular via a central hydraulic pump and corresponding valves.

A central release may have a central release mechanism housing. The central release mechanism housing has the function of accommodating components of the central release mechanism, in particular the movable central release mechanism piston, and protecting them from external mechanical or chemical influences. Furthermore, the central release mechanism housing has the function of allowing for simple installation and fixing of the central release mechanism within the brake system. The central release mechanism housing can be made in one piece or in multiple pieces. The central release mechanism housing can be formed from a plastic, a metallic material and/or a ceramic material. The central release mechanism piston chamber formed in the central release mechanism housing serves to accommodate and guide the central release mechanism piston, which is linearly movably mounted in the central release mechanism housing.

The central release mechanism also has a central release mechanism piston. The central release mechanism piston has the function of converting hydraulic pressurization into a linear displacement of the central release mechanism piston, the effect of which is that the clutch system can be transferred from an engaged operating state to a disengaged operating state. The central release mechanism can have an annular central release mechanism piston or multiple central release mechanism pistons (multi-piston release mechanisms).

Furthermore, the central release mechanism may have at least one central release mechanism piston seal. The central release mechanism piston seal seals the linearly movably guided central release mechanism piston with respect to the central release mechanism housing that accommodates the central release mechanism piston. The central release mechanism piston seal can be designed in particular as a sealing ring. The central release mechanism piston seal may be formed from an elastic, e.g., rubber-elastic material. The elastic material can consist entirely or partially of an elastomer, and the elastomers in turn may be selected from the group of natural rubber vulcanizates and silicone rubber.

In a hydraulic release system of a motor vehicle, the hydraulic liquid has the function of transmitting energy in the form of pressure with as little loss as possible, for example within a vehicle clutch system. In addition to this main task, the hydraulic liquid can in particular also provide lubrication and corrosion protection for the moving parts and the metal surfaces of the hydraulic release system. In addition, it can in particular also dissipate impurities (for example due to abrasion), water, air and waste heat.

According to a further embodiment, it is possible for the central release mechanism piston and/or central release mechanism housing to be formed from a plastic. This has the effect that the central release mechanism can be manufactured cost-effectively and designed in a weight-optimized manner.

The release bearing may be an angular contact ball bearing having two bearing rings, an inner ring and an outer ring, each of which has a radial flange (inner ring leg/outer ring leg) that extends in the direction of the bearing axis of rotation or away from it. The inner ring leg or outer ring leg of the rotating bearing ring is operatively connected to the carrier segment of the brake shoe carrier so that, in the case of an axial force on the other inner ring leg/outer ring leg and the resulting axial displacement of the release bearing, the drum brake either opens or closes. The axial forces required for this can be generated, for example, by the hydraulically actuated central release mechanism, the piston of which is connected to the stationary bearing ring.

According to a further embodiment, it is possible for the brake system to have a brake cooling circuit for dissipating heat from the drum brake. The dissipated heat can be made available to a thermal management system of the motor vehicle, in particular by means of a heat exchanger.

The brake system can also be implemented in such a way that at least one cooling channel that can be connected to the brake cooling circuit is formed in or on the brake housing and/or brake drum. In particular, this can also be connected to the thermal management system of the motor vehicle, for example via a heat exchanger.

In the context of the present disclosure, the term thermal management refers to the demand-oriented and efficient control of thermal energy flows in an electrically drivable motor vehicle, in particular a battery-powered motor vehicle, according to the prevailing operating or load condition.

The thermal management system of the motor vehicle can include a hydraulic control system. A hydraulic control system directs the volume flows within a thermal management system of a motor vehicle by means of switching elements that act hydraulically on a fluid, such as valves, slides, pumps and the suchlike. The hydraulic control system can, for example, completely or partially throttle a volume flow and/or distribute it to the relevant heat sources and sinks in sub-circuits of the thermal management system of a motor vehicle. For this purpose, the hydraulic switching elements are controlled and switched by the electronic control unit.

A hydraulic switching element can be a hydraulic pump, a switching valve, a controllable throttle valve and the suchlike. A hydraulic switching element may be electrically controllable. Furthermore, a hydraulic switching element may have at least two different, switchable operating states in which the hydraulic switching element acts in different ways on the corresponding fluid in a circuit.

According to an example embodiment, it is therefore possible for the brake to have a brake cooling circuit for dissipating or supplying heat from or to the brake, and the hydraulic control unit acts on the brake cooling circuit by means of at least one hydraulic switching element to influence the volume flows in the brake cooling circuit.

According to an example embodiment, it is possible for the electric machine to have a motor cooling circuit for dissipating or supplying heat from or to the electric machine, and the hydraulic control unit acts on the motor cooling circuit by means of at least one hydraulic switching element to influence the volume flows in the motor cooling circuit.

According to an example embodiment, it is possible for the thermal management system to further include an inverter with an inverter cooling circuit for dissipating or supplying heat from or to the inverter, and the hydraulic control unit acts on the inverter cooling circuit by means of at least one hydraulic switching element to influence the volume flows in the inverter cooling circuit.

According to an example embodiment, it is possible for the vehicle battery to have a battery cooling circuit for dissipating or supplying heat from or to the vehicle battery, and the hydraulic control unit acts on the battery cooling circuit by means of at least one hydraulic switching element to influence the volume flows in the battery cooling circuit.

According to a further development, it is also possible for the drum brake to have at least one axially and radially movable brake shoe which can be moved into a frictionally locking connection with a shell surface of the brake drum by the brake actuator actuating in the axial direction, the brake shoe interacting with the brake housing in such a way that an axial displacement of the brake shoe also causes a radial displacement of the brake shoe.

The cooling channels can therefore be permanently located in the rotationally fixed brake housing or the rotationally fixed brake drum near the friction surfaces and therefore do not need to be integrated into the brake shoe. This makes the connection easier since the cooling channels are not in motion in relation to the brake housing or brake drum. In addition, the actuating unit—hydraulic or electromechanical—can be positioned away from said friction surface to protect the hydraulics or electronics from heat.

According to a further embodiment, it is possible for the brake actuator to be arranged radially outside the brake drum, which may be advantageous for a number of given installation space situations. Furthermore, the brake actuator can also be positioned spatially separately from the regions of the drum brake that are subject to particular thermal stress. Finally, the brake system can also be designed in such a way that the brake actuator and the brake shoe are arranged radially inside the brake drum, and a friction lining is fixed to the radially inner shell surface of the brake drum and/or a friction lining is fixed to the radially outer contact surface of the brake shoe, which can also be favorable for a number of installation space situations, in particular if the drum brake has to be compact in design.

Furthermore, the brake system can also be further developed in such a way that a friction lining is fixed to the radially outer shell surface of the brake drum and/or a friction lining is fixed to the radially inner contact surface of the brake shoe, whereby the braking effect of the drum brake can be further improved.

In an example embodiment, it is also possible for at least one cooling channel connectable to the brake cooling circuit to be formed in or on the brake housing. The brake system may be developed in such a way that the cooling channel runs in the region of the second ramp portion, which allows good heat transfer without the need for cooling channels to be guided through moving parts of the drum brake.

According to a further embodiment, it is possible for the brake actuator to be designed as a hydraulic or electromechanical actuator.

The brake system can also be implemented in such a way that the brake is configured as a dry-running brake. The brake system may be designed as a ‘dry’ brake system that has cooling channels or cooling hoses in one of the brake components-e.g., in the non-rotating brake component. A coolant, for example a water-glycol mixture or a cooling oil, is transported through these to the thermal management system of the motor vehicle. Compared to a ‘wet’ (multi-disk) brake system, a ‘dry’ brake system generates fewer losses when not actuated, and the coefficient of friction and therefore the braking torque is more constant.

### BRIEF DESCRIPTION OF THE DRAWINGS

The present disclosure is explained in more detail below with reference to figures without limiting the general concept of the disclosure.

In the figures:

FIG. 1 shows an axle drivetrain including a brake system in a schematic axial sectional view;

FIG. 2 shows a motor vehicle including an electric drivetrain in a schematic block diagram; and

FIG. 3 shows a brake system in a schematic axial sectional view.

### DETAILED DESCRIPTION

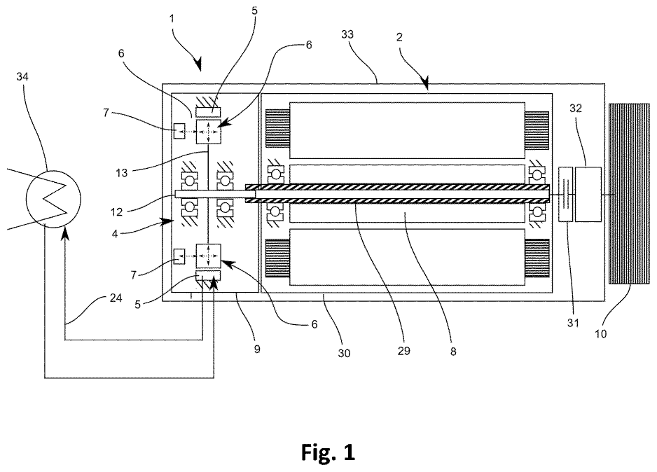

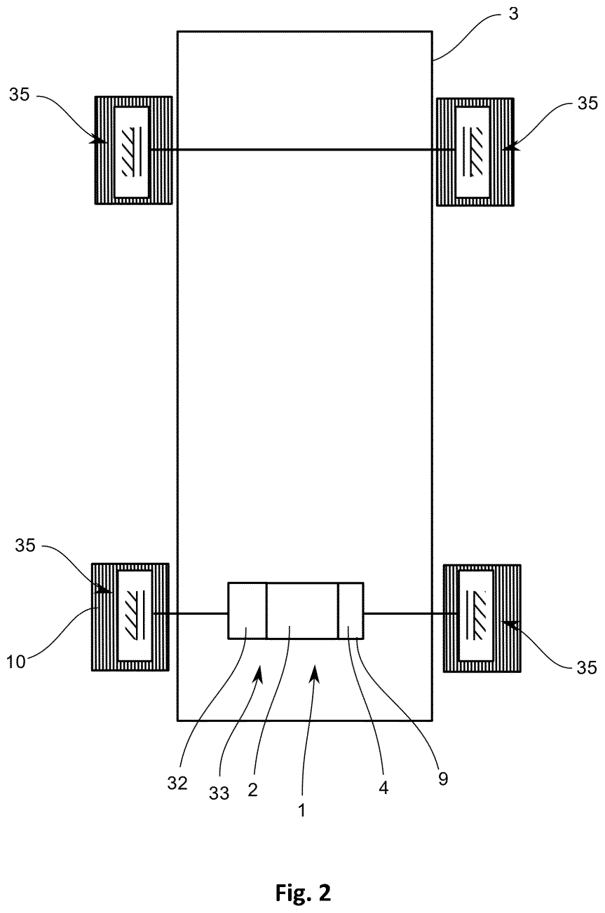

FIG. 1 shows a brake system 1 of a motor vehicle 3 which can be driven electrically by means of an electric machine 2, as is also shown by way of example in FIG. 2.

The transmission 32, the electric machine 2 and the drum brake 4 form a structural unit, which is also referred to as the axle drivetrain 33. In order to decouple the electric machine 2 from the vehicle wheel 10 and thus allow a coasting mode of the axle drivetrain 33, a separating clutch 31 is arranged in the torque path between the electric machine 2 and the vehicle wheel 10.

The brake system 1 includes a drum brake 4 having a brake drum 5, which can be loaded with a frictional torque by means of at least one brake shoe 6 that can be moved radially in the direction of the brake drum 5 by a brake actuator 7. The electric machine 2 accommodated in the motor housing 30 has a rotor 8 which is coupled in a torque-transmitting manner to at least one vehicle wheel 10 of the motor vehicle 3.

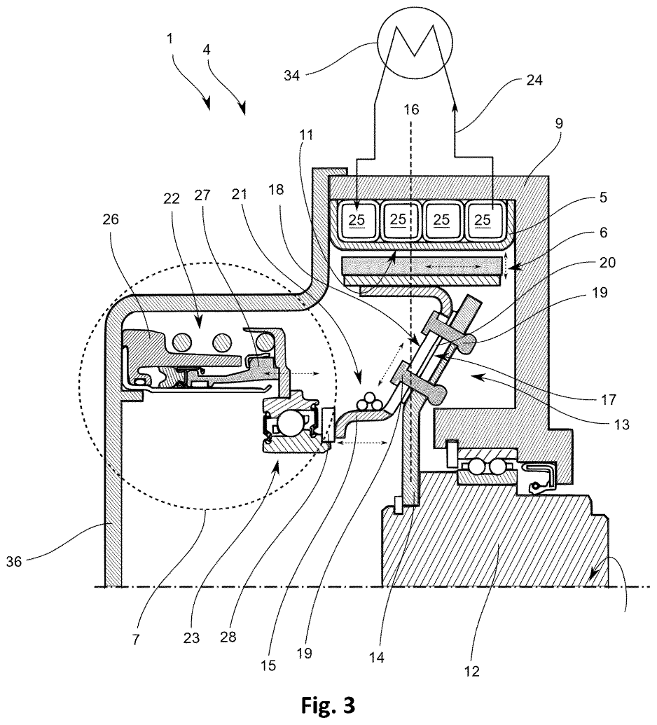

The drum brake 4 is accommodated in a brake housing 9 and the brake shoe 6, which rotates during operation, is connected to the rotor 8 of the electric machine 2 in a torque-transmitting manner and is mounted so as to be axially and radially movable relative to the rotationally fixed brake drum 5, such that the brake shoe 6 can be moved into a frictionally locking connection with a shell surface 11 (ref. FIG. 3) of the rotationally fixed brake drum 5 by the brake actuator 7 actuating in the axial direction.

In this configuration, three different deceleration torques can therefore act on one or more of the vehicle wheels 10: the deceleration torque generated by the drum brake 4, the deceleration torque generated by the electric machine 2 and/or the deceleration torque generated by the service brake system 35 (ref. FIG. 2). Depending on the driving situation and deceleration requirements, these three available deceleration torques can be combined and applied in a controlled manner.

As can be clearly seen from FIG. 3, the brake actuator 7 is coupled to a brake shoe carrier 13 which carries the brake shoe 6, is connected in a rotationally fixed manner to a rotatably mounted brake shaft 12 and which converts an axial release movement of the brake actuator 7 into a radial displacement movement of the brake shoe 6. For this purpose, the brake shoe carrier 13 has a coupling ring 14 which is connected to the brake shaft 12 in a rotationally fixed manner, for example via a tooth system, and at least one carrier segment 15 which can be moved relative to the coupling ring 14 and to which the brake shoe 6 is fixed. The coupling ring 14, which is formed from sheet metal, has a sliding portion 17 which is tilted relative to a radial plane 16 and on which the carrier segment 15 is displaceably guided such that axial actuation of the carrier segment 15 results in a radial displacement of the brake shoe 6.

An elongated hole 18 extending in the direction of displacement is formed in the carrier segment 15, which elongated hole is penetrated by at least one guide means 19 extending from the sliding portion 17 through the elongated hole 18, such that the carrier segment 15 is guided movably in the direction of displacement and captively relative to the coupling ring 14. A sliding segment 20 is arranged between the carrier segment 15 and the sliding portion 17 to reduce friction and improve the sliding of the carrier segment 15 relative to the sliding portion 17. In the exemplary embodiment shown, this sliding segment 20 is a thin disk that has a low coefficient of friction.

The spring force of a spring element 21 acts with a spring force component directed radially inwards on the carrier segment 15.

In the exemplary embodiment shown in FIG. 3, the brake actuator 7 is designed as a hydraulically actuatable central release mechanism 22, which acts via the translationally displaceable central release mechanism piston 27 on a release bearing 23 arranged in the release direction between the central release mechanism 22 and the carrier segment 15, which release bearing in turn can be coupled to the carrier segment 15 via the thrust disk 28 to transmit the release movement. In the present case, the release system is substantially identical to a hydraulic release system of a clutch, consisting of the central release mechanism 22 with an axially hydraulically displaceable central release mechanism housing 26 and the release bearing 23.

The brake system 1 has a brake cooling circuit 24 to dissipate heat from the drum brake 4. At least one cooling channel 25 that can be connected to the brake cooling circuit 24 is formed in or on the brake housing 9 and/or brake drum 5. In order to dissipate the heat generated by the braking energy, the brake drum 5 is cooled by a cooling system comprising one or more cooling channels 25 in the exemplary embodiment shown in FIG. 3. In this way, braking energy can be recovered or used to heat the transmission 32 and/or a traction battery of the motor vehicle 3 via the heat exchanger 34 arranged in the brake cooling circuit 24.

The drum brake 4 is accommodated in the brake housing 9, which is closed by the brake housing cover 36, which is screwed to the brake housing 9. The rotatably mounted brake shaft 12, which can be coupled to the rotor shaft 29 of the electric machine 2, for example by means of a spline, is arranged in the brake housing 9. The brake shaft 12 and the brake housing 9 are sealed against each other by a radial shaft seal ring, not described in detail.

A plurality of carrier segments 15 may be present and mounted on the coupling ring 14. All of these carrier segments 15 are guided in a radially displaceable manner on the coupling ring 14 as soon as they are subjected to an axial force. For example, 3 or 6 carrier segments 15 may be arranged equidistantly around the circumference of the coupling ring 14.

The torque is transferred between the coupling ring 14 and a carrier segment 15 by the guide means 19 installed in the coupling ring 14, which are designed as rivets in the exemplary embodiment shown in FIG. 3. These rivets then each also form a guide for a linearly displaceable carrier segment 15. For example, a slot or—as shown in FIG. 3—an elongated hole 18 is formed in the carrier segment 15 for this purpose The carrier segment 15 can move radially outwards within this slot or elongated hole 18. To prevent the carrier segments 15 from moving outwards unintentionally due to centrifugal forces, they are held by the spring element 21. This also ensures that the parts of the brake shoe carrier 13 that are displaceable against each other are moved back to their original position (unactuated) after actuation. As there is an influence of centrifugal force on the brake shoe 6, a correction force must be adopted in the actuation strategy. The faster the brake shoes 6 rotate, the less axial force is required to actuate the drum brake 4.

The disclosure is not limited to the embodiments shown in the figures. The above description is therefore not to be regarded as limiting, but rather as illustrative. The following claims are to be understood as meaning that a stated feature is present in at least one embodiment of the invention. This does not exclude the presence of further features. Where the claims and the above description define ‘first’ and ‘second’ features, this designation serves to distinguish between two features of the same type without defining an order of precedence.

### REFERENCE NUMERALS

1 Brake system
2 Electric machine
3 Motor vehicle
4 Drum brake
5 Brake drum
6 Brake shoe
7 Brake actuator
8 Rotor
9 Brake housing
10 Vehicle wheel
11 Shell surface
12 Brake shaft
13 Brake shoe carrier
14 Coupling ring
15 Carrier segment
16 Radial plane
17 Sliding portion
18 Elongated hole
19 Guide means
20 Sliding segment
21 Spring element
22 Central release mechanism
23 Release bearing
24 Brake cooling circuit
25 Cooling channel
26 Central release mechanism housing
27 Central release mechanism piston
28 Thrust disk
29 Rotor shaft
30 Motor housing
31 Separating clutch
32 Transmission
33 Axle drivetrain
34 Heat exchanger
35 Service brake system
36 Brake housing cover

1. A brake system (1) of a motor vehicle (3) which can be driven electrically by means of an electric machine (2), wherein the brake system (1) comprises a drum brake (4) having a brake drum (5), which can be loaded with a frictional torque by means of at least one brake shoe (6) which can be moved radially in the direction of the brake drum (5) by a brake actuator (7), and the electric machine (2) has a rotor (8) which is coupled in a torque-transmitting manner to at least one vehicle wheel (10) of the motor vehicle (3),
characterized in that
the drum brake (4) is received in a brake housing (9) and the brake shoe (6) is connected to the rotor (8) of the electric machine (2) in a torque-transmitting manner and is mounted so as to be axially and radially movable relative to the rotationally fixed brake drum (5) so that the brake shoe (6) can be moved into a frictionally locking connection with a shell surface (11) of the brake drum (5) by the brake actuator (7) actuating in the axial direction.

2. The brake system (1) according to claim 1,
characterized in that
the brake actuator (7) is coupled to a brake shoe carrier (13) which carries the brake shoe (6) and is connected in a rotationally fixed manner to a rotatably mounted brake shaft (12) and which converts an axial release movement of the brake actuator (7) into a radial displacement movement of the brake shoe (6).

3. The brake system (1) according to claim 2,
characterized in that
the brake shoe carrier (13) has a coupling ring (14) which is connected in a rotationally fixed manner to the brake shaft (12) and at least one carrier segment (15) which can be moved relative to the coupling ring (14) and to which the brake shoe (6) is fixed.

4. The brake system (1) according to claim 3,
characterized in that
the coupling ring (14) has a sliding portion (17) which is tilted relative to a radial plane (16) and on which the carrier segment (15) is displaceably guided.

5. The brake system (1) according to claim 3 or 4,
characterized in that
an elongated hole (18) extending in the direction of displacement is formed in the carrier segment (15), which elongated hole is penetrated by at least one guide means (19) extending from the sliding portion (17) through the elongated hole (18), such that the carrier segment (15) is guided movably in the direction of displacement and captively relative to the coupling ring (14).

6. The brake system (1) according to any one of claims 3-5,
characterized in that
a sliding segment (20) is arranged between the carrier segment (15) and the sliding portion (17).

7. The brake system (1) according to any one of claims 3-6,
characterized in that
the spring force of a spring element (21) acts with a radially inwardly directed spring force component on the carrier segment (15).

8. The brake system (1) according to any one of claims 3-7,
characterized in that
the brake actuator (7) is designed as a hydraulically actuatable central release mechanism (22), which acts on a release bearing (23) arranged in the release direction between the central release mechanism (22) and the carrier segment

(15) which release bearing in turn can be coupled to the carrier segment (15) to transmit the release movement.

9. The brake system (1) according to any one of the preceding claims,
characterized in that
the brake system (1) has a brake cooling circuit (24) for dissipating heat from the drum brake (4).

10. The brake system (1) according to claim 9,
characterized in that
at least one cooling channel (25) that can be connected to the brake cooling circuit (24) is formed in or on the brake housing (9) and/or brake drum (5).
